(19) United States
(12) Patent Application Publication
(10) Pub. No.: US 2010/0116889 A1
(43) Pub. Date: May 13, 2010

(54) Imaging reader with efficient laser illumination

(76) Inventor: Miklos Stern, Woodmere, NY (US)

Correspondence Address: MOTOROLA, INC., 1303 EAST ALGONQUIN ROAD, IL01/3RD, SCHAUMBURG, IL, 60196, US

(21) Appl. No.: 12/291,288

(22) Filed: Nov. 7, 2008

(51) Int. Cl. G06K 7/10

(52) U.S. Cl. 235/462.42

(57) ABSTRACT

An imaging reader for, and a method of, electro-optically reading a symbol by image capture employ an illuminating assembly that includes a laser for directing an illuminating laser beam along a path to the symbol to illuminate the symbol during image capture, a diffusing assembly that includes a movable diffuser in the path of the illuminating laser beam to diffuse the illuminating laser beam as diffused illuminating laser light, and a solid-state imager that includes an array of image sensors for capturing the diffused illuminating laser light returned from the symbol in a range of working distances over a field of view.

### DESCRIPTION OF THE RELATED ART

Solid-state imaging systems or imaging readers, as well as moving laser beam readers or laser scanners, have both been used to electro-optically read targets, such as one-dimensional bar code symbols, particularly of the Universal Product Code (UPC) type, each having a row of bars and spaces spaced apart along one direction, as well as two-dimensional symbols, such as Code 49, which introduced the concept of vertically stacking a plurality of rows of bar and space patterns in a single symbol, as described in U.S. Pat. No. 4,794,239. Another two-dimensional code structure for increasing the amount of data that can be represented or stored on a given amount of surface area is known as PDF417 and is described in U.S. Pat. No. 5,304,786.

The imaging reader includes an imaging module having a solid-state imager with a sensor array of cells or photosensors, which correspond to image elements or pixels in a field of view of the imager, and an imaging lens assembly for capturing return light scattered and/or reflected from the symbol being imaged in a range of working distances from the imager, and for projecting the return light onto the sensor array to initiate capture of an image of the symbol. Such an imager may include a one- or two-dimensional charge coupled device (CCD) or a complementary metal oxide semiconductor (CMOS) device and associated circuits for producing and processing electronic signals corresponding to a one- or two-dimensional array of pixel information over the field of view.

It is therefore known to use the imager for capturing a monochrome image of the symbol as, for example, disclosed in U.S. Pat. No. 5,703,349. It is also known to use the imager with multiple buried channels for capturing a full color image of the symbol as, for example, disclosed in U.S. Pat. No. 4,613,895. It is common to provide a two-dimensional CCD with a 640×480 resolution commonly found in VGA monitors, although other resolution sizes are possible.

In order to increase the amount of the return light captured by the imager, especially in dimly lit environments and/or at long working distance range reading, the imaging module generally also includes an illuminating light assembly having one or more light emitting diodes (LEDs) for illuminating the symbol with illumination light for reflection and scattering therefrom. In many applications, it is desirable to increase the efficiency of the illumination light and to increase the range of working distances by replacing the LEDs with a laser source operative for emitting a laser beam that is more intense and brighter than LED light. Light of greater intensity will increase the working distance range, because there will be correspondingly more return light for the imager to detect from symbols that are further away from the imaging reader. Also, the laser beam is diffraction limited and, hence, can be directed more efficiently toward the symbol, as compared to light originating from other, non-diffraction limited light sources, such as LEDs.

However, the use of the laser source introduces the inherent problem of speckle noise, which can cause considerable degradation in image quality. A monochromatic (red, blue or green) laser emits a laser beam having coherent waves of the same frequency and also having spatial coherence, that is, the waves have a fixed phase relationship with one another both in space and in time. When the laser beam is incident on a target symbol, the waves are scattered by being reflected from the symbol. The scattered waves have random phase delays and propagate along different directions, but all have the same frequency. When such scattered waves meet, for example, at the imager, they produce a static distribution of constructive and destructive interference, i.e., an interference pattern, also known as speckle noise. The imager sees the speckle noise as a degraded image. Reading performance is thus corrupted.

### SUMMARY OF THE INVENTION

One feature of the present invention resides, briefly stated, in an imaging reader for, and a method of, electro-optically reading a symbol by image capture. The reader includes a housing, an illuminating assembly supported by the housing and including a laser for directing an illuminating laser beam along a path to the symbol to illuminate the symbol during image capture, a diffusing assembly supported by the housing and including a movable diffuser in the path of the illuminating laser beam to diffuse the illuminating laser beam as diffused illuminating laser light, and a solid-state imager, such as a CCD or a CMOS, supported by the housing and including an array of image sensors for capturing the diffused illuminating laser light returned from the symbol in a range of working distances over a field of view.

In the preferred embodiment, the array is one-dimensional, i.e., linear, or is two-dimensional with an anamorphic field of view. The housing has a handle for handheld operation and also has a light-transmissive window through which the diffused illuminating laser light passes in one direction, and through which the returned captured light passes in an opposite direction.

Advantageously, the diffuser is a light-transmissive element having a textured or diffractive surface, or is integrated with scattering particles, for scattering the illuminating laser beam. A drive, preferably a motor, is operative for moving the diffuser, preferably by rotating the diffuser about the path.

In accordance with this invention, the efficiency of the illuminating light and the range of working distances for the imaging reader has been increased due to the use of the illuminating laser whose bright, intense, diffraction limited light, as compared to LED light, enables more return light to be detected by the imager. Yet, the inherent problem of speckle noise introduced by the illuminating laser is minimized by the moving diffuser, which changes the phase relationship of the illuminating laser beam, and causes averaging of different speckle patterns on the imager.

The method of electro-optically reading a symbol by image capture is performed by illuminating the symbol by directing an illuminating laser beam along a path to the symbol during image capture, diffusing the illuminating laser beam by moving a diffuser in the path of the illuminating laser beam to produce diffused illuminating laser light, and capturing the diffused illuminating laser light returned from the symbol in a range of working distances over a field of view.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a portable imaging reader operative in either a handheld mode, or a hands-free mode, for capturing return light from target symbols; and

FIG. 2 is a schematic diagram of various components of the reader of FIG. 1 in accordance with the present invention.

### DETAILED DESCRIPTION OF THE PREFERRED EMBODIMENTS

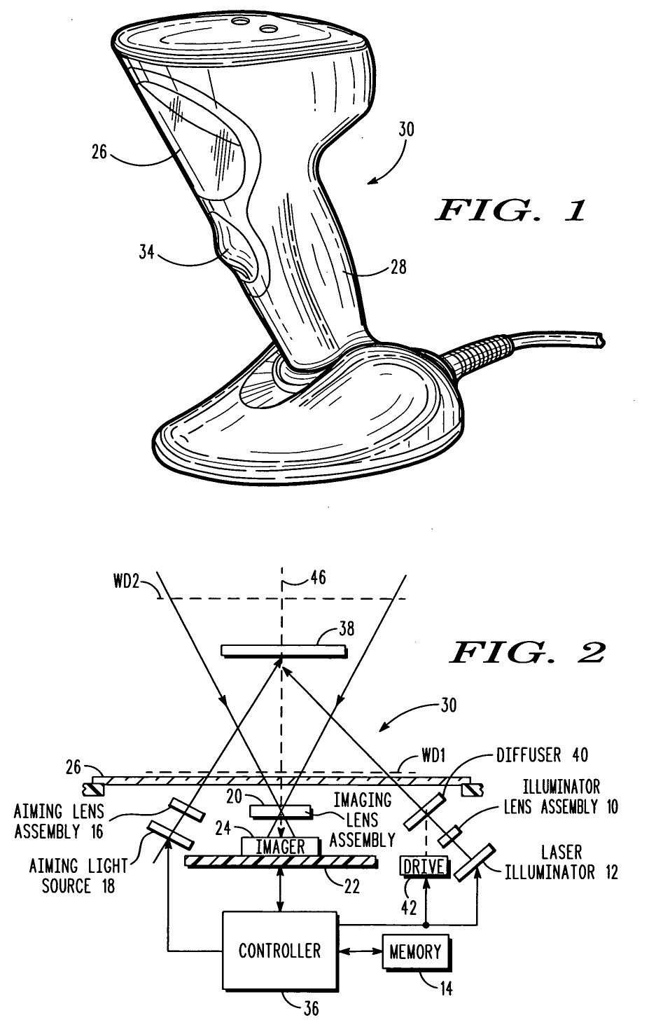

Reference numeral 30 in FIG. 1 generally identifies an imaging reader having a generally vertical window 26 and a gun-shaped housing 28 supported by a base 32 for supporting the imaging reader 30 on a countertop. The imaging reader 30 can thus be used in a hands-free mode as a stationary workstation in which products are slid, swiped past, or presented to, the vertical window 26, or can be picked up off the countertop and held in an operator's hand and used in a handheld mode in which a trigger 34 is manually depressed to initiate imaging of indicia, especially one-dimensional symbols, to be read at far distances from the window 26. In another variation, the base 32 can be omitted, and housings of other configurations can be employed. A cable, as illustrated in FIG. 1, connected to the base 32 can also be omitted, in which case, the reader 30 communicates with a remote host by a wireless link, and the reader is electrically powered by an on-board battery.

As schematically shown in FIG. 2, an imager 24 is mounted on a printed circuit board 22 in the reader. The imager 24 is a solid-state device, for example, a CCD or a CMOS imager having a one-dimensional array of addressable image sensors or pixels arranged in a single, linear row, or a two-dimensional array of such sensors arranged in mutually orthogonal rows and columns, preferably with an anamorphic field of view, and operative for detecting return light captured by an imaging lens assembly 20 along an optical path or axis 46 through the window 26. The return light is scattered and/or reflected from a target or symbol 38 over the field of view. The imaging lens assembly 20 is operative for adjustably focusing the return light onto the array of image sensors to enable the symbol 38 to be read. The symbol 38 is located anywhere in a working range of distances between a close-in working distance (WD1) and a far-out working distance (WD2). In a preferred embodiment, WD1 is about four to six inches from the imager array 24, and WD2 can be many feet from the window 26, for example, around fifty feet away.

An illuminating assembly is also mounted in the imaging reader and preferably includes an illuminator or illuminating light source 12, e.g., a laser, and an illuminating lens assembly 10 to uniformly illuminate the symbol 38 with an illuminating laser beam.

An aiming assembly is also mounted in the imaging reader and preferably includes an aiming light source 18, e.g., an LED or a laser, and an aiming lens assembly 16 for generating an aiming light pattern or mark on the symbol 38.

As shown in FIG. 2, the imager 24, the illuminating light source 12 and the aiming light source 18 are operatively connected to a controller or microprocessor 36 operative for controlling the operation of these components. A memory 14 is connected and accessible to the controller 36. Preferably, the microprocessor is the same as the one used for processing the return light from target symbols and for decoding the captured target images.

In operation, the microprocessor 36 sends a command signal to energize the aiming light source 18 prior to reading, and also pulses the illuminating laser 12 for a short exposure time period, say 500 microseconds or less, and energizes and exposes the imager 24 to collect light, e.g., illumination laser light and/or ambient light, from a target symbol only during said exposure time period. A typical array needs about 16 to 33 milliseconds to acquire the entire target image and operates at a frame rate of about 30 to 60 frames per second.

One aspect of the present invention resides in providing a diffusing assembly in the housing 28. The diffusing assembly includes a movable diffuser 40 positioned in the path of the illuminating laser beam to diffuse the illuminating laser beam as diffused illuminating laser light, and a drive 42 operatively connected to, and controlled by, the controller 36 for moving the diffuser 40. The imager captures the diffused illuminating laser light returning from the symbol 38 in an extended range of working distances WD1-WD2 over the field of view.

Advantageously, the diffuser 40 is a light-transmissive, translucent element having a textured or diffractive surface, or is integrated with scattering particles, for scattering the illuminating laser beam. The drive 42 is preferably an electric motor operative for moving the diffuser 40, preferably by rotating the diffuser 40 about the path, to randomly scatter the illuminating laser beam. The drive 42 could also move the diffuser 40 transversely of the path.

In accordance with this invention, the efficiency of the illuminating light and the range of working distances for the imaging reader 30 has been increased due to the use of the laser 12 whose bright, intense, diffraction limited light, as compared to LED light, enables more return light to be detected by the imager 24. Yet, the inherent problem of speckle noise introduced by the laser 12 is minimized by the moving diffuser 40, which changes the phase relationship of the illuminating laser beam, and causes averaging of different speckle patterns on the imager 24.

As previously noted, a laser can also be used as the aiming light source 18. The aiming lens assembly 16 for generating the aiming light pattern can include all optical element such as a hologram to create a specific aiming pattern. This optical element could, in accordance with another aspect of this invention, be configured as a movable plate having one section that contains the hologram, and another section that contains the diffuser. When the images captures light from the symbol, the plate begins to move and intercepts the laser beam with the section that contains the diffuser, thus creating the diffuse illumination needed. Alternatively, the beam can be switched in some other way between the hologram and the diffuser.

It will be understood that each of the elements described above, or two or more together, also may find a useful application in other types of constructions differing from the types described above.

While the invention has been illustrated and described as a reader for, and a method of, reading a symbol to be read by image capture with efficient laser illumination, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

I claim:

1. An imaging reader for electro-optically reading a symbol by image capture, comprising:
a housing;
an illuminating assembly supported by the housing, and including a laser for directing an illuminating laser beam along a path to the symbol to illuminate the symbol during image capture;
a diffusing assembly supported by the housing, and including a movable diffuser in the path of the illuminating laser beam to diffuse the illuminating laser beam as diffused illuminating laser light; and
a solid-state imager supported by the housing, and including an array of image sensors for capturing the diffused illuminating laser light returned from the symbol in a range of working distances over a field of view.

2. The reader of claim 1, wherein the housing has a handle for handheld operation.

3. The reader of claim 1, wherein the housing has a light-transmissive window through which the diffused illuminating laser light passes in one direction, and through which the returned captured light passes in an opposite direction.

4. The reader of claim 1, wherein the diffuser is a light-transmissive element having a textured surface for scattering the illuminating laser beam.

5. The reader of claim 1, wherein the diffuser is a light-transmissive element integrated with scattering particles for scattering the illuminating laser beam.

6. The reader of claim 1, wherein the diffusing assembly includes a drive for moving the diffuser.

7. The reader of claim 6, wherein the drive is operative for rotating the diffuser about the path.

8. The reader of claim 1, wherein the array is a linear array.

9. A method of electro-optically reading a symbol by image capture, comprising the steps of:
illuminating the symbol by directing an illuminating laser beam along a path to the symbol during image capture;
diffusing the illuminating laser beam by moving a diffuser in the path of the illuminating laser beam to produce diffused illuminating laser light; and
capturing the diffused illuminating laser light returned from the symbol in a range of working distances over a field of view.

10. The method of claim 9, wherein the steps are performed in a housing having a handle for handheld operation.

11. The method of claim 9, wherein the illuminating step is performed by passing the diffused illuminating laser light in one direction through a light-transmissive window, and wherein the capturing step is performed by passing the returned captured light in an opposite direction through the window.

12. The method of claim 9, and the step of configuring the diffuser as a light-transmissive element having a textured surface for scattering the illuminating laser beam.

13. The method of claim 9, and the step of configuring the diffuser as a light-transmissive element integrated with scattering particles for scattering the illuminating laser beam.

14. The method of claim 9, wherein the moving step is performed by rotating the diffuser about the path.

15. The method of claim 9, and the step of configuring the array as a linear array.
